(19) United States
(12) Patent Application Publication
(10) Pub. No.: US 2026/0353315 A1
(43) Pub. Date: Nov. 5, 2026

(54) DEVICE AND METHOD FOR TRANSMITTING OR RECEIVING SIGNAL IN WIRELESS COMMUNICATION SYSTEM

(71) Applicant: LG ELECTRONICS INC., Seoul (KR)

(72) Inventors: Kijun JEON, Seoul (KR); Sangrim LEE, Seoul (KR); Ikjoo JUNG, Seoul (KR); Taehyun LEE, Seoul (KR)

(73) Assignee: LG ELECTRONICS INC., Seoul (KR)

(21) Appl. No.: 19/108,009

(22) PCT Filed: Sep. 1, 2022
(86) PCT No.: PCT/KR2022/013085

§ 371 Date: Feb. 28, 2025

(51) Int. Cl. H04W 56/00; G06F 9/48

(52) U.S. Cl. CPC H04W 56/001; G06F 9/4806

(57) ABSTRACT

The present disclosure may provide a method for operating a first device in a wireless communication system. The method for operating a first device may comprise the steps of: receiving a synchronization signal from a second device; performing a synchronization procedure with the second device on the basis of the synchronization signal; receiving channel coding-related information through higher layer signaling; receiving control information including data coding information based on the channel coding-related information from the second device; and decoding data on the basis of the channel coding-related information and data coding information. Here, the channel coding-related information is based on shared information, and the shared information may include background knowledge including relationship information between subtask layer states of each of concatenated subtask layers.

### CROSS-REFERENCE TO RELATED APPLICATION(S)

This application is the National Stage filing under 35 U.S.C. 371 of International Application No. PCT/KR2022/013085, filed on Sep. 1, 2022, the contents of which is hereby incorporated by reference herein in its entirety.

### TECHNICAL FIELD

The present disclosure relates to a wireless communication system, and more particularly, to a device and method for transmitting/receiving a signal in a wireless communication system.

Specifically, the present disclosure may provide a method and apparatus for semantic source coding of a signal to be transmitted and received in semantic communication.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

As an example of the present disclosure, a method for operating a first device in a wireless communication system may include receiving a synchronization signal from a second device, establishing connection by performing a synchronization procedure with the second device based on the synchronization signal, receiving control information and first data from the second device, and performing a task based on the first data. The control information may include semantic control information (SCI), and the task may be performed through the first data, the SCI and shared information.

In addition, as an example of the present disclosure, a method for operating a second device in a wireless communication system may include transmitting a synchronization signal to a first device, establishing connection by performing a synchronization procedure with the first device based on the synchronization signal, and transmitting control information and first data to the first device. The control information may include semantic control information (SCI), the first data may be used to perform a task, and the task may be performed through the first data, the SCI and shared information.

In addition, as an example of the present disclosure, a first device in a wireless communication system may include a transceiver and a processor coupled with the transceiver. The processor may be configured to receive a synchronization signal from a second device, to establish connection by performing a synchronization procedure with the second device based on the synchronization signal, to receive control information and first data from the second device, and to perform a task based on the first data. The control information may include semantic control information (SCI), and the task may be performed through the first data, the SCI and shared information.

In addition, as an example of the present disclosure, a second device in a wireless communication system may include a transceiver and a processor coupled with the transceiver. The processor may be configured to transmit a synchronization signal to a first device, to establish connection by performing a synchronization procedure with the first device based on the synchronization signal, and to transmit control information and first data to the first device. The control information may include semantic control information (SCI), the first data may be used to perform a task, and the task may be performed through the first data, the SCI and shared information.

In addition, as an example of the present disclosure, a device may include at least one memory and at least one processor functionally coupled with the at least one memory. The at least one processor may control the device to receive a synchronization signal from a second device, to establish connection by performing a synchronization procedure with the second device based on the synchronization signal, to receive control information and first data from the second device, and to perform a task based on the first data. The control information may include semantic control information (SCI), and the task may be performed through the first data, the SCI and shared information.

In addition, as an example of the present disclosure, a non-transitory computer-readable medium storing at least one instruction may include the at least one instruction that is executable by a processor. The at least one instruction may be configured to receive a synchronization signal from a second device, to establish connection by performing a synchronization procedure with the second device based on the synchronization signal, to receive control information and first data from the second device, and to perform a task based on the first data. The control information may include semantic control information (SCI), and the task may be performed through the first data, the SCI and shared information.

In addition, the following may be commonly applied.

As an example of the present disclosure, shared information may be background knowledge that a first device and a second device share based on a semantic layer, and first data may be feature information that is extracted from second data for a task based on the semantic layer.

In addition, as an example of the present disclosure, a task may consist of at least one or more subtasks, and first data, which is feature information, may be extracted from second data for a task through semantic encoding based on shared information.

In addition, as an example of the present disclosure, concatenated subtask layers may be configured based on a task, and shared information may include a subtask state transition matrix set indicating relationship information of subtask layer output states of each of the concatenated subtask layers.

In addition, as an example of the present disclosure, extracted first data may consist of feature vectors that are extracted from concatenated subtask layers.

In addition, as an example of the present disclosure, when a first feature vector is extracted from a first subtask layer among concatenated subtask layers based on semantic encoding, association information between an output state of a second subtask layer, which is a subtask layer preceding the first subtask layer, and an output state of the first subtask layer may be identified through a first subtask state transition matrix for the first subtask layer, and the first feature vector of the first subtask layer may be extracted based on a second feature vector of the second subtask layer and a first dataset of the first subtask layer.

In addition, as an example of the present disclosure, an output state of a second subtask layer and a second feature vector may be determined based on at least one or more subtask layers that are located before the second subtask layer.

In addition, as an example of the present disclosure, concatenated subtask layers may form a concatenated sub-deep neural network (DNN) structure, and each feature vector may be extracted from each of the concatenated subtask layers through a sub-DNN.

In addition, as an example of the present disclosure, when there are subtasks decoupled from concatenated subtask layers, each of the decoupled subtasks may use a different sub-DNN.

In addition, as an example of the present disclosure, when a task is performed through first data that is received based on shared information, the task may be performed through semantic decoding in concatenated subtask layers.

In addition, as an example of the present disclosure, concatenated subtask layers may form a concatenated sub-deep neural network (DNN) structure, and semantic decoding may be performed in each of the concatenated subtask layers through a sub-DNN.

In addition, as an example of the present disclosure, when semantic decoding is performed in a first subtask layer among concatenated subtask layers, the semantic decoding may be performed through semantic decoding output information of a second subtask layer, which is a subtask layer preceding the first subtask layer, and a received first feature vector of the first subtask layer.

In addition, as an example of the present disclosure, when there are subtasks decoupled from concatenated subtask layers, each of the decoupled subtasks may use a different sub-DNN.

In addition, as an example of the present disclosure, SCI may be control information for configuring a semantic encoder and a semantic decoder and include information on at least one of a method for selecting a neural network (NN) model, a type of a task, and a depth of a layer necessary for performing the type of the task.

As is apparent from the above description, the embodiments of the present disclosure have the following effects.

The present disclosure may improve communication performance by performing semantic source coding through background knowledge in a wireless communication system.

The present disclosure may utilize a small deep neural network (DNN) with an optimal size according to each decoupled subtask in a wireless communication system.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure.

### BRIEF DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of a hand-held device applicable to the present disclosure.

FIG. 5 is a view showing an example of a car or an autonomous driving car applicable to the present disclosure.

FIG. 6 is a view showing an example of artificial intelligence (AI) device applicable to the present disclosure.

FIG. 7 is a view showing a method of processing a transmitted signal applicable to the present disclosure.

FIG. 8 is a view showing an example of a communication structure providable in a 6th generation (6G) system applicable to the present disclosure.

FIG. 9 is a view showing an electromagnetic spectrum applicable to the present disclosure.

FIG. 10 is a view showing a THz communication method applicable to the present disclosure.

FIG. 11A illustrates examples of existing communication systems according to an embodiment of the present disclosure.

FIG. 11B illustrates examples of communication systems according to an embodiment of the present disclosure.

FIG. 12A illustrates an example of a protocol stack for semantic communication according to an embodiment of the present disclosure.

FIG. 12B illustrates another example of a protocol stack for semantic communication according to an embodiment of the present disclosure.

FIG. 13 illustrates an example of a subtask matrix set according to an embodiment of the present disclosure.

FIG. 14 illustrates an example of a semantic encoder and decoder structure based on background knowledge according to an embodiment of the present disclosure.

FIG. 15 illustrates an example of a deep neural network (DNN) structure of a semantic encoder according to an embodiment of the present disclosure.

FIG. 16 illustrates an example of a semantic decoder according to an embodiment of the present disclosure.

FIG. 17 illustrates a semantic encoding and decoding procedure according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

Communication system applicable to the present disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

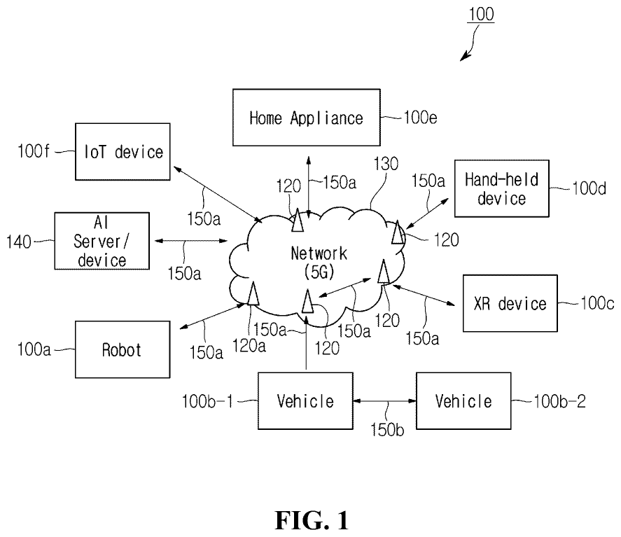

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

Communication system applicable to the present disclosure

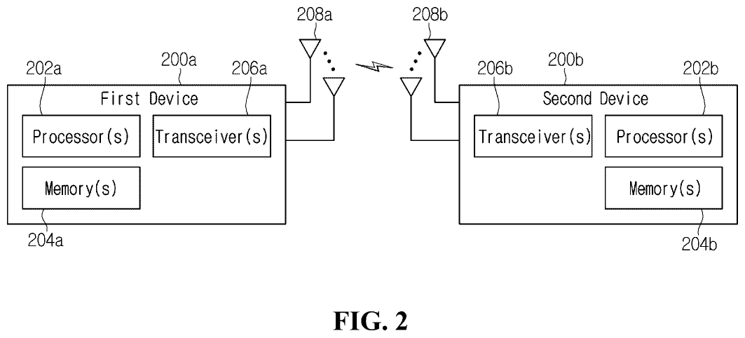

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

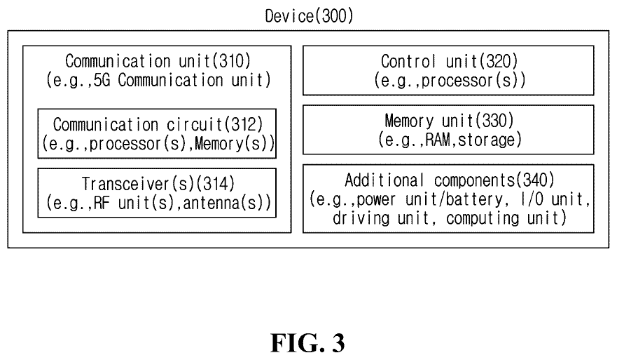

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

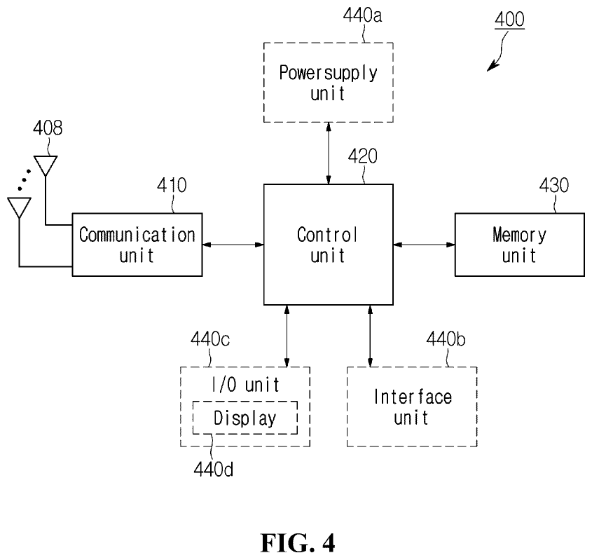

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

Type of wireless device applicable to the present disclosure

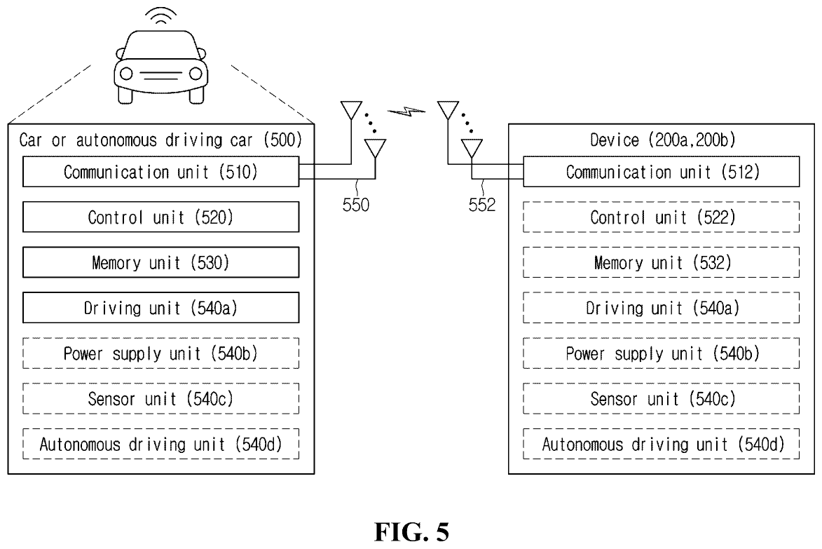

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

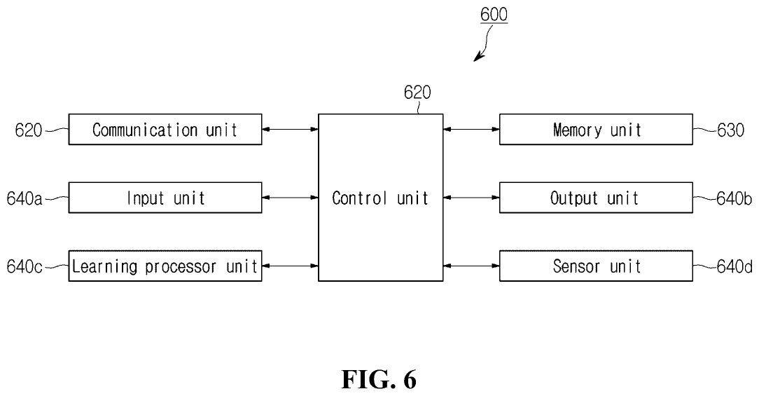

FIG. 6 is a view showing an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 650c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

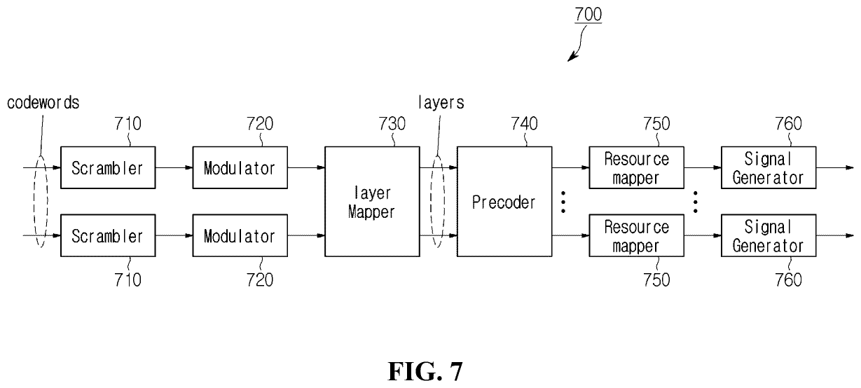

FIG. 7 is a view showing a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

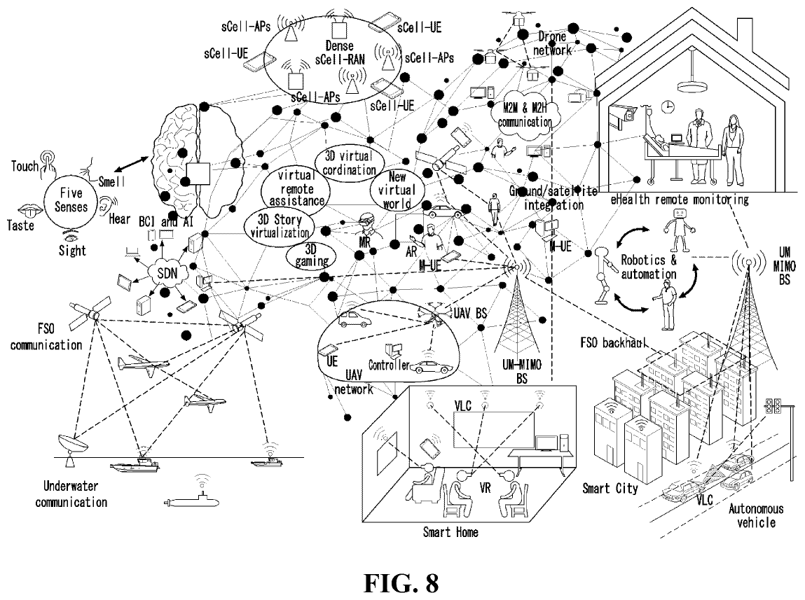

FIG. 8 is a view showing an example of a communication structure providable in a 6G system applicable to the present disclosure.

Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-THz communication with wide bandwidth and applying advanced massive MIMO technology.

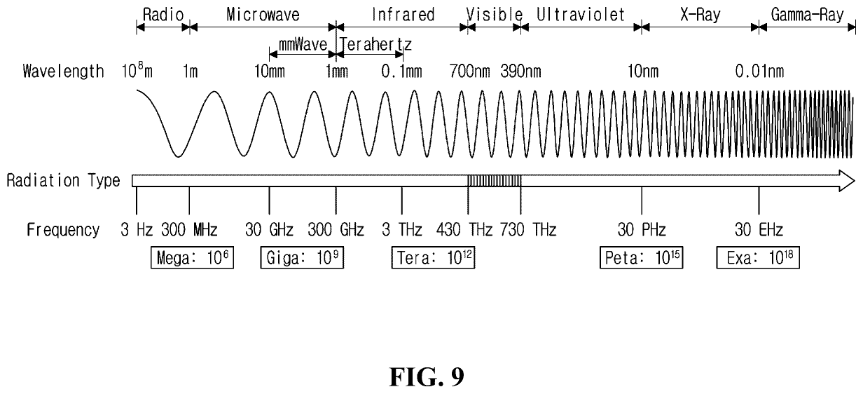

FIG. 9 is a view showing an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

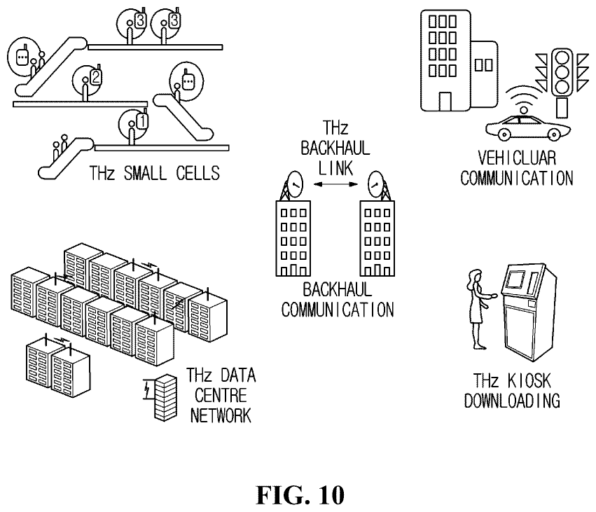

FIG. 10 is a view showing a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Specific Embodiments of the Present Disclosure

Based on Shannon's philosophy, the existing communication systems have been developed through a metric focusing on data rates such as throughput, frequency and energy efficiency, and latency speed. That is, studies on the existing communication systems have been actively performed to achieve successful transmission and reception of symbols. However, as the existing communication systems do not consider a transmission strategy, meaning of data and relationship of data, an unnecessary resource may be used to transmit less related-information, and there may be a limitation in performing 6G communication that requires massive data transmission and reception.

The ultimate purpose of communication is to exchange the ‘meaning’ of information. In this regard, the meaning of transmitted data, which has not been considered, is deemed to have an important role in the next generation communication, and semantic communication based on the concept of ‘meaning conveyance’ emerges as one paradigm for the next-generation wireless communication.

Semantic communication refers to a communication system that uses common information (e.g., background knowledge) shared by a transmitted and a receiver to efficiently transmit and receive semantic information. Semantic communication is a high-efficiency communication method considering the meaning of transmitted data and is capable of transmitting and processing data at the speed of data traffic that increases exponentially. Furthermore, it is expected that by the year 2029, a lot of devices employing many artificial intelligence (AI) technologies will be developed along with the commercialization of 6G communication, and thus semantic communication will be used to convey meaning accurately and quickly in communication among AI devices and between AI devices and humans.

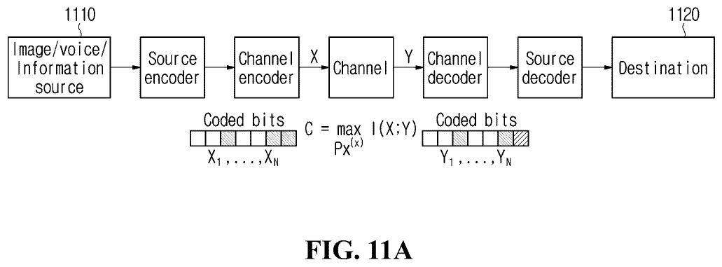

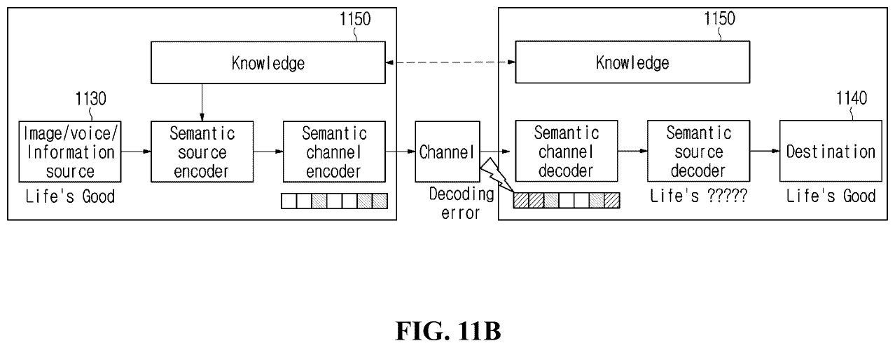

FIG. 11A and FIG. 11B illustrate examples of communication systems according to an embodiment of the present disclosure. Referring to FIG. 11A, the existing communication focuses on decoding by a destination 1120 an encoded signal received from a source 1110 into an original signal without error. On the other hand, referring to FIG. 11B, like human communication that exchanges information through the ‘meaning’ of a word, semantic communication focuses on a meaning to be conveyed through a signal. The essence of semantic communication is that a destination extracts the ‘meaning’ of information transmitted from a source. Semantic information may be successfully ‘interpreted’ through a common knowledge base between a source 1130 and a destination. Thus, even when a signal has an error, if an operation is performed according to meaning to be conveyed through the signal, communication is performed rightly. Accordingly, the approach of semantic communication needs to consider whether a task at a destination 1140 is performed as intended by a signal (e.g., representation) transmitted from the source 1130. To this end, a transmitted signal should be generated in consideration of a task located at a destination.

As semantic information may significantly reduce energy and wireless resources that are necessary to transmit data, semantic information may be used for online meeting, augmented reality (AR), and virtual reality (VR). Accordingly, in recent years, studies are actively performed on a method for performing semantic encoding and decoding by using a deep neural network (DNN) for semantic communication. Specifically, there are ongoing studies that aim to expand the classic theory of information to semantic information theory (e.g., definition of semantic entropy, definition of semantic mutual information). In addition, there are also ongoing studies that define a loss function metric based on a wide meaning of semantic entropy and channel capacity and construct a semantic encoder and decoder using a DNN based on the defined metric.

Meanwhile, most studies for semantic information focus on extracting a feature including a whole feature sequence from an embedding vector with respect to a semantic encoder and focus on extracting a suitable output for a task purpose from a latent vector with respect to a semantic decoder. The semantic encoder may optimally perform compression by extracting a feature in consideration of every component of data. However, in this case, because the sizes of embedding vectors, which are inputs of the semantic encoder and the semantic decoder, become large, each DNN mode size becomes large (large-scale model). In addition, there is a disadvantage in that the importance of extracted features is difficult to select or a feature with an error is difficult to determine among extracted features.

Thus, in consideration of what is described above, the present disclosure proposes a new semantic source coding method. Specifically, the present disclosure proposes a semantic source coding method that decomposes tasks into a plurality of subtasks by using background knowledge and uses a semantic layered encoder/decoder consisting of layers according to each decomposed subtask.

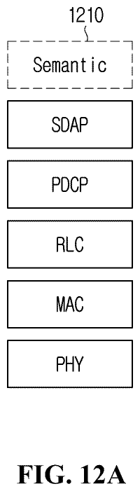

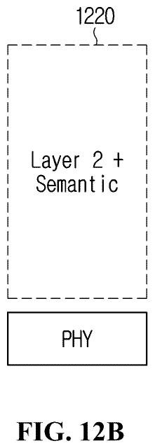

Meanwhile, as compared with the existing communication, semantic communication may need a semantic layer 1210. FIG. 12A and FIG. 12B illustrate an example of a protocol stack for semantic communication according to an embodiment of the present disclosure. Considering a protocol stack of a user data plane, there may be a MAC layer, a RLC layer, a PDCP layer and an SDAP layer above a PHY layer. Herein, the MAC layer, the RLC layer, the PDCP layer and the SDAP layer may be Layer 2. As an example, an existing wireless communication system (e.g., LTE) may have no SDAP layer but may not be limited thereto. Herein, referring to FIG. 12A, the semantic layer 1210 may be present above the SDAP layer. As an example, the semantic layer 1210 may be used to extract a suitable feature for a task purpose from original data. Being present above the SDAP layer, the semantic layer 1210 may forward the extracted feature to the SDAP layer. Then, the extracted feature may be transmitted from a transmitted to a receiver, and a task may be performed at the receiver according to the feature. That is, the feature may be used to perform the task, and the original data may be processed into a form that conveys meaning by using background knowledge through the semantic layer.

Based on what is described above, semantic communication may be a method of inferring meaning through background knowledge of a transmitter and a receiver and be a form of communication that processes data by extracting a suitable feature for each task purpose.

As another example, a configuration for meaning inference may be different according to each configured task, and a feature extraction method may be different. Herein, the semantic layer 1210 is present above an SDAP layer but may be configured in association with each layer in Layer 2.

As a specific example, each task may have a different syntax error condition for meaning inference. That is, considering meaning inference, an extent to which a syntax error is allowed may be differently configured for each task, and a HARQ/ARQ feedback configuration may be configured differently by considering a task. In consideration of what is described above, when a feature is extracted by considering a specific task to be performed in the semantic layer 1210 and the task is performed by forwarding processed data (or the extracted feature) to a lower layer, an operation of considering the task of the semantic layer 1210 in the lower layer may become different, and thus the semantic layer 1210 may be configured in association with layers in Layer 2. As another example, referring to FIG. 12B, the semantic layer 1220 may merge with Layer 2. Specifically, layer merging based on an artificial intelligence (AI) may be considered. That is, the semantic layer 1220 may not exist as a separate layer but merge with Layer 2. As an example, the semantic layer 1220 may merge with each of layers in Layer 2. As another example, the semantic layer 1220 may operate by merging with Layer 2 through an AI, and thus each layer in Layer 2 may perform an operation in consideration of semantic communication. That is, a semantic layer may merge or be associated with an existing protocol stack but may not be limited to a specific embodiment.

As an example, a method will be described below that feature information is extracted from original data by using background knowledge through a semantic encoder of a transmitter based on a semantic layer and a task is performed by using the feature information received through a semantic decoder of a receiver and the background knowledge. In addition, for configurations of the semantic encoder and the semantic decoder, control information (e.g., a neural network (NN) model selection method, layer depth information) may be forwarded based on the semantic layer, which will be described below.

Hereinafter, for theories necessary for operations and signaling through a semantic layer, Information bottleneck theory and the coupled subtask will be described.

### Information Bottleneck Theory

Information bottleneck theory is a theory derived from the rate distortion theory. Information bottleneck theory may be expressed by Equation 1 below based on relevant information. The relevant information is an output corresponding to an objective of a label or task.

L[p(s|x)]=min_{p(s|x)}I(S;X)−βI(S;Y) [Equation 1]

In Equation 1, X is an original data signal space, S is a compressed signal (e.g., feature) space, and Y is a relevant information signal space. β is a Lagrange multiplier, having a positive value. According to Equation 1, if I(S;X) has a smaller value and I(S;Y) has a larger value, relevant information has a minimum value. Accordingly, if I(S;X) has a smaller value, the compressed signal S is independent from the original data X to a greater extent, and if I(S;Y) has a larger value, the compressed signal S represents the relevant information Y best. That is, the compressed signal S is a latent vector that extracts only a feature of the relevant information Y from the original data X. Equation 1 may be reformulated into Equation 2 below.

min_{p(y|s)}min_{p(s|x)}/(S;X)+βE[KL(p(y|x)|p(y|s))] [Equation 2]

In Equation 2, KL(a|b) is a Kullback-Leibler divergence. The Kullback-Leibler divergence means how similar a probability distribution a and a probability distribution b are to each other. p(s|x) corresponds to a semantic encoder, and p(y|s) corresponds to a semantic decoder.

### Coupled Subtask and its Data/Label Set

Hereinafter, a task to which the present disclosure is to be applied, decomposition of data/label set associated with the task, coupling of decomposed subtasks, and coupling of partial data/partial labels will be described.

A task may be decomposed into a plurality of subtasks. The subtasks thus decomposed are each assumed to have a random relationship. As a task may be decomposed into subtasks with different domains, the subtasks may be multi-layer subtasks. Each of the subtasks thus decomposed may correspond to one layer.

Meanwhile, a task may be expressed by tuples of decomposed subtasks. In addition, data and labels related to subtasks may be expressed by tuples. Herein, since there is a random relation between each subtask, outputs (e.g., states) of each subtask layer may have dependency on outputs of a previous task layer. That is, task layer outputs, which are decoupled from each other in previous task layers, may pass through a current subtask layer and transition to outputs of different subtask layers. Hereinafter, two embodiments will be described to enhance understanding of a task.

### 1) Factory Automation Case

As an example, a factory automation case may be assumed. Herein, a task may be to determine for a robot ‘what, where and how to do’. Herein, the task may be ‘what, where and how to do’. The task may be decomposed into subtasks of ‘what’, ‘where’ and ‘how’.

Accordingly, the task may be expressed by a subtask tuple (A, B, C). As an example, A may represent a thing-related subtask, B may represent a place-related subtask, and C may represent an action-related subtask. In addition, a candidate place may be determined (or decomposed) according to a thing, and an action may be determined (or decomposed) according to the determined place.

As an example, if the task of a robot is to cook in an unmanned food court, depending on cooking ingredients that is determined as the first subtask, a place of cooking by the cooking ingredients may be determined as the second subtask, and cooking methods using the cooking ingredients may be determined as the third subtask.

### 2) Image Inference Case

As another example, it is assumed that a task has an objective of inferring the name of an animal in a random animal image. In order to infer the name of an animal from an animal image, the task may be partially decomposed into subtasks of identifying the appearance of animals. As an example, the subtasks of the task may be tasks of identifying a top part (e.g., head), a middle part (e.g., body), and a bottom part (e.g., leg) respectively. In addition, the task may be expressed by a subtask tuple (A, B, C).

A may represent a subtask related to a top appearance, B may represent a subtask related to a middle appearance, and C may represent a subtask related to a bottom appearance. Herein, if the animal in an image is determined (or classified) to be a mammal or bird as a result of the subtask A, the subtask B may infer characteristics and perform classification with focus on difference between mammals and birds (e.g., color/texture of body fur for mammals, color/texture of feather and wing shapes for birds). Accordingly, data and labels may be decoupled because they include feature information based on such difference.

Considering what is described above, the present disclosure proposes a method of performing semantic layered encoding and decoding based on background knowledge that is information including relation information among subtask layer states and is shared between a transmitter and a receiver. The relation information among subtask layer states may be expressed by a subtask state transition matrix set (hereinafter, ‘subtask matrix set’) described below.

### Background Knowledge: Subtask State Transition Matrix Set

A subtask matrix set may be used as background knowledge and represents a relation between subtask layers. Equation 3 below expresses the subtask matrix set.

$$𝕋 = {\{ {T}^{( m )} \}}_{m = 1}^{M} \qquad [ Equation 3 ]$$

In Equation 3, T^{(m)} is a subtask state transition matrix of an m-th layer

$$( {N}_{in}^{( m )} \times {N}_{out}^{( m )} )$$

(hereinafter, ‘subtask matrix’). Here, the row

$${N}_{in}^{( m )}$$

means an index of available subtask combinations up to (m−1)-th layers, and the column

$${N}_{out}^{( m )}$$

means an available state index of an m-th subtask. If 1 is present in the row index and the column index, it means that a transition is possible between corresponding subtask states. Accordingly, a subtask tuple corresponding to a j-th row index in T^{(m)} may be expressed by Equation 4 below.

ρ(j;m)=(y₁,y₂, . . . ,yₘ₋₁) [Equation 4]

In Equation 4, yᵢ means a subtask output state of an i-th layer. A subtask output state of an m-th layer may be coupled as shown in Equation 5 below.

$${\{ l \}}_{l = 1}^{{N}_{out}^{( m )}} ⇒ {⋃}_{l = 1}^{{d}_{m}} {𝒪}_{l}^{( m )} where 𝒥 ( {T}_{n}^{( m )} ) ⊂ {𝒪}_{l}^{( m )} for ∃ l , m > 1 and {𝒪}_{l}^{( m )} \neq {𝒪}_{j}^{( m )} = for ∀ l \neq j \qquad [ Equation 5 ]$$

In Equation 5,

$${T}_{n}^{( m )}$$

means an n-th row vector of T^{(m)}, and J(a) means a collection set of indexes with nonzero elements in a vector a. Accordingly, Equation 5 is an index set of available outputs in an m-th subtask layer. In Equation 5,

$${N}_{out}^{( m )}$$

is an output type, and dₘ is the number of decoupled subsets. Herein, if subtask output states of an (m−1)-th layer are included in different coupling subsets, the corresponding subtask may not transition to a same subtask state in the m-th layer.

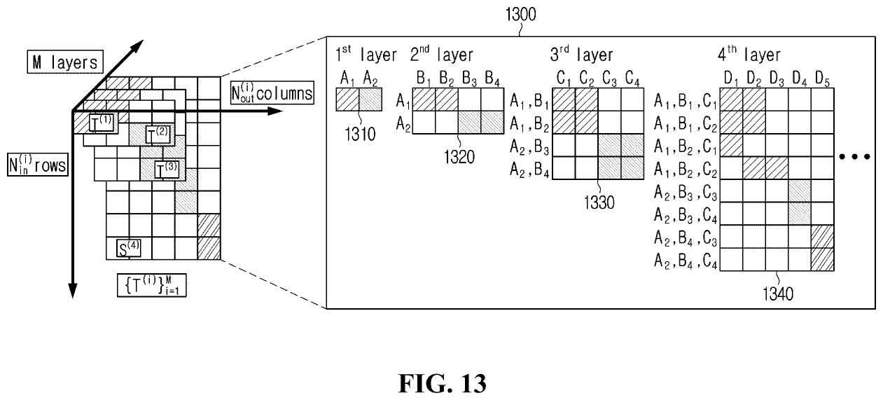

FIG. 13 illustrates an example of a subtask matrix set 1300 according to an embodiment of the present disclosure. Referring to FIG. 13, a first subtask layer 1310 is

$${𝒪}_{1}^{( 1 )} = \{ {A}_{1} \} , {𝒪}_{2}^{( 1 )} = \{ {A}_{2} \} ,$$

a second subtask layer 1320 is

$${𝒪}_{1}^{( 2 )} = \{ {B}_{1} , {B}_{2} \} , {𝒪}_{2}^{( 2 )} = \{ {B}_{3} , {B}_{4} \} ,$$

a third subtask layer 1330 is

$${𝒪}_{1}^{( 3 )} = \{ {C}_{1} , {C}_{2} \} , {𝒪}_{2}^{( 3 )} = \{ {C}_{3} , {C}_{4} \} ,$$

and a fourth subtask layer 1340 is

$${𝒪}_{1}^{( 3 )} = \{ {D}_{1} , {D}_{2} , {D}_{3} \} , {𝒪}_{2}^{( 3 )} = \{ {D}_{4} \} , {𝒪}_{3}^{( 3 )} = \{ {D}_{5} \} .$$

### Layer Construction Order

Hereinafter, a method of constructing layers of a semantic encoder and decoder when decomposing a task into subtasks will be described. Herein, the present disclosure assumes that the deeper the layer, the more precise the information handled. That is, a subtask for relatively conventional information is handled in a low layer, and a task for private information or subtask-dependent information is handled in a high layer. Thus, because subtask outputs, which are decoupled in a previous layer, are not coupled again in a current layer, there may be an advantage in that a small deep neural network (DNN) with optimal size is available for each coupled subtask.

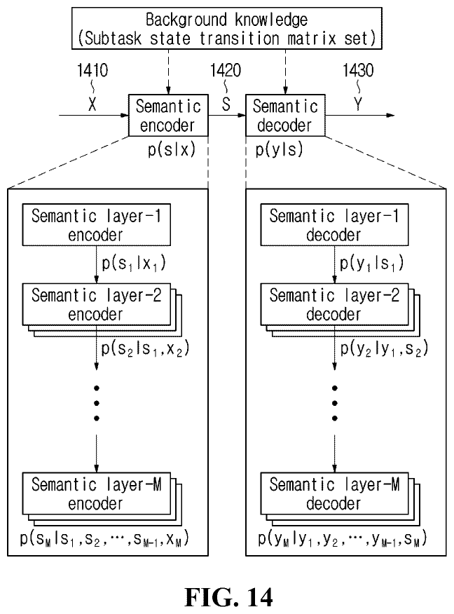

FIG. 14 illustrates an example of a semantic encoder and decoder structure based on background knowledge according to an embodiment of the present disclosure.

Referring to FIG. 14, a whole data space is represented by X 1410, a label space is represented by Y 1430, and a compressed feature space is represented by S 1420. Herein, the label space may include relevant information.

Herein, samples (e.g., x∈X, y∈Y, s∈S) included in each of the spaces may be partial vector components of each subtask or a concatenated form of a partial data sequence and a partial layer sequence corresponding to each subtask.

In FIG. 14, the semantic encoder is p(s|x). Herein,

$$s = {[ {s}_{i} ]}_{i = 1}^{M}$$

is an M-domain compressed signal (feature) vector, and

$$y = {[ {y}_{i} ]}_{i = 1}^{M}$$

are various vectors for data vectors. As an example, a domain may be a subtask. An output of a current subtask layer is affected by data corresponding to the current subtask layer and an output state sequence of previously accumulated subtask layers. As the encoder shares a subtask matrix set as background knowledge, p(s|x) may be approximated by being decomposed as in Equation 6 below.

p(s|x)≅p(s₁|x₁)p(s₂|x₂,s₁)p(s₃|x₃,s₁,s₂) . . . p(s_{M}|x_{M},s₁,s₂, . . . ,s_{M-1}) [Equation 6]

In Equation 6, to obtain an m-th conditional pdf, that is, p(sₘ|x_{M}, s₁, s₂, . . . , s_{M-1}) when training the semantic encoder, it is necessary to secure a probability distribution of p(s₁, s₂, . . . , sₘ₋₁) and a corresponding input vector set. A probability distribution and an input vector set may be obtained from a DNN corresponding to a conditional pdf, which is determined in previous subtask layers, and output samples from data samples.

A compressed feature vector sₘ for an m-th subtask layer may be interpreted as a feature vector that is progressively generated by recursively using a data vector of a current subtask layer and concatenated feature vectors

$${[ {s}_{i} ]}_{i = 1}^{m - 1}$$

generated from previous subtask layers.

In addition, as shown in Equation 6, when the semantic encoder p(s|x) is decomposed, it may mean that a large scale single DNN is decomposed into concatenated small scale DNNs. Herein, a DNN corresponding to a conditional pdf of each layer constructs a different DNN structure according to each decoupled subtask state set, thereby realizing a slim DNN structure. This may also be applied to a decoder in a similar way.

p(y|s)≅p(y₁|s₁)p(y₂|s₂,y₁)p(y₃|s₃,y₁,y₂) . . . p(y_{M}|s_{M},y₁,y₂, . . . ,y_{M-1}) [Equation 7]

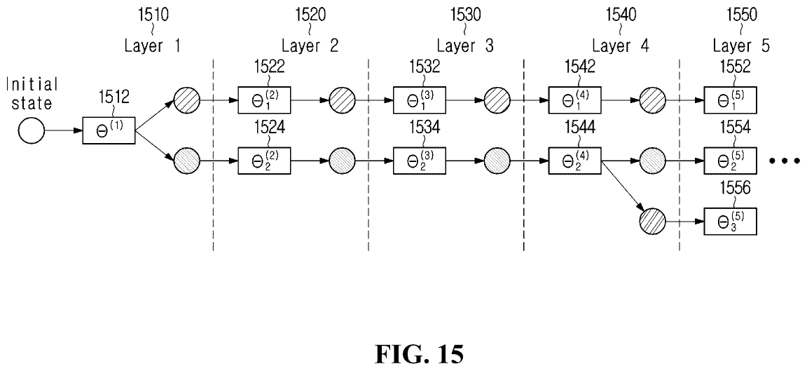

In Equation 7, a decoder performs a task corresponding to a subtask progressively in each subtask layer in a sequential way. Referring to FIG. 15, an encoder or a decoder performs a task corresponding to a subtask progressively. The encoder and the decoder generate a compressed feature vector for each m-th subtask layer. Herein, Equation 8 may express a case in which only a portion of feature vectors generated from previous subtask layers is required or task output feature vectors of specific subtask layers are used as an input due to coupling.

p(s|x)≈p(1|x₁)p(s₂|x₂,\tilde{s}₁)p(s₃|x₃,\tilde{s}₂) . . . p(s_{M}|x_{M},\tilde{s}_{M- 1}) [Equation 8]

In case a partial feature vector is extracted from each layer, the variable \tilde{S}ₘ of Equation 8 may be expressed by Equation 9 below. In Equation 9, \ddot{s}ᵢ is a partial vector of sᵢ∈ [symbol] .

\tilde{S}ₘ∈ [symbol] [Equation 9]

In case a feature vector is selectively constructed in each layer, the variable \tilde{s}ₘ of Equation 8 may be expressed by Equation 10. In Equation 10, \tilde{s}ᵢ is a partial vector of sᵢ∈ [symbol] .

\tilde{s}ₘ∈ [symbol] [Equation 10]

[symbol] is a layer index set that is used as an input of an m-th layer. In addition, when a subtask of each layer should perform multiple operations (e.g., reconstruction and classification), relevant information Y is also configured in multiple forms (e.g., existing data and label).

FIG. 15 illustrates an example of a deep neural network (DNN) structure of a semantic encoder according to an embodiment of the present disclosure. The semantic encoder may include a plurality of layers 1510, 1520, 1530, 1540 and 1550. Each of the layers 1510, 1520, 1530, 1540 and 1550 may include a concatenation of DNNs and a coupled task state.

Referring to FIG. 15,

$${θ}_{l}^{( i )}$$

represents a parameter corresponding to a DNN 1 of an i-th layer. In each layer, a circle means a coupled task state. As an example, the circle on the top in Layer 4 1540 may mean a first coupled task state D₁, D₂, D₃, the second circle from the top may mean a coupled task state D₄, and the third circle from the top may mean a coupled task state D₅. If they are applied to the unmanned robot of the above-described factory automation case, Layer 1 1510 may correspond to information on things, Layer 2 1520 and Layer 3 1530 may correspond to information on places, and Layer 4 1540 and Layer 5 1550 may correspond to information on actions. In addition, if they are applied to the image inference case, Layer 1 1510 may correspond to information on a top part, Layer 2 1520 and Layer 3 1530 may correspond to information on a middle part, and Layer 4 1540 and Layer 5 1550 may correspond to information on a bottom part.

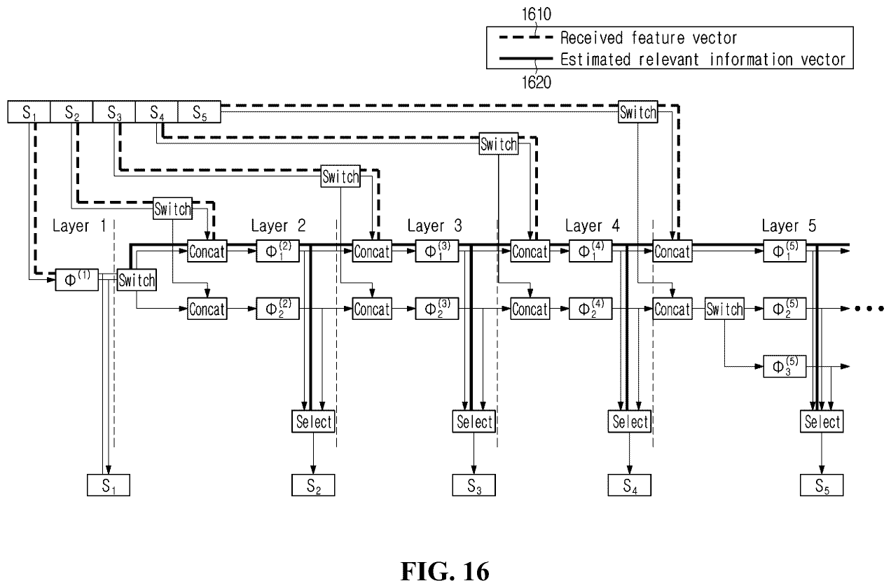

FIG. 16 illustrates an example of a semantic decoder according to an embodiment of the present disclosure. The semantic encoder of FIG. 16 may be a semantic encoder for the multi-layer task of FIG. 14.

Lines 1610 and 1620 shown in FIG. 16 represent flows of a received feature vector and an estimated relevant information vector respectively.

$${Φ}_{l}^{( i )}$$

of FIG. 16 is a parameter corresponding to DNN 1 of an i-th Layer 1. The semantic decoder may generate an embedding input vector by concatenating a relevant information vector obtained from a previous subtask and a feature vector received from a current subtask. The semantic decoder may obtain a relevant information vector for a current subtask layer by using the generated embedding input vector.

### Semantic Control Information (SCI) and SCI Exchange Protocol

Meanwhile, in order to apply the present disclosure, control information for generating a feature including semantic information is required. As an example, a server and an AI device may exchange information on a task type and a layer depth for performing a task of the type.

Table 2 below illustrates a format of semantic control information (SCI).

TABLE 2

| Format | Usage |
|---|---|
| Format 0_0 | Notifying task type from UE to server |
| Format 1_0 | Notifying subtask layer depth from UE to server |
| Format 0_1 | Notifying task type from server to UE |
| Format 1_1 | Notifying subtask layer depth from server to UE |

In addition, SCI may be used to exchange information on a task between a server and an AI device. As an example, when a connection configuration is completed between the server and the AI device, the AI device or the server may report information on a current task to be performed by it by using the SCI. The server or the AI device may generate feature information by performing semantic layered encoding based on the SCI and transmit the generated feature information. The AI device or the server may perform the task based on the received feature information and task information.

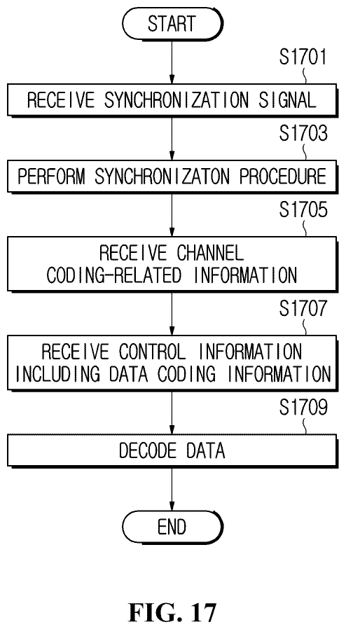

FIG. 17 illustrates a semantic encoding and decoding procedure according to an embodiment of the present disclosure.

Referring to FIG. 17, at step S1701, a terminal may receive a synchronization signal from a base station. At step S1703, the terminal may perform a synchronization procedure with the base station based on the synchronization signal.

At step S1705, the terminal may receive channel coding-related information through upper layer signaling. At step S1707, control information including data coding information based on the channel coding-related information may be received from the base station. Herein, the upper layer may be a semantic layer. The semantic layer may be used to extract a suitable feature for a task purpose from original data. In addition, control information for semantic communication may be delivered between the terminal and the base station through the semantic layer.

The channel coding-related information may include background knowledge including relationship information between respective subtask layer states. The background knowledge may be information shared between the terminal and the base station. As an example, as a concatenated structure, subtask layers may decomposed layers for performing a task.

At step S1709, data may be decoded based on the channel coding-related information and the data coding information. The data coding information may be vector information of the subtask layers in a concatenated structure. The terminal may generate an embedding input vector by concatenating a relevant information vector obtained from a subtask and a feature vector received from a current subtask, thereby decoding data.

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

1. A method comprising:
receiving a synchronization signal from a second device;
performing a synchronization procedure with the second device based on the synchronization signal;
receiving control information and first data from the second device; and
performing a task based on the first data,
wherein the control information includes semantic control information (SCI), and the task is performed through the first data, the SCI and shared information.

2. The method of claim 1, wherein the shared information is background knowledge that the first device and the second device share based on a semantic layer, and
wherein the first data is feature information that is extracted from second data for the task based on the semantic layer.

3. The method of claim 2, wherein the task consists of at least one or more subtasks, and
wherein the first data, which is the feature information, is extracted from the second data for the task through semantic encoding based on the shared information.

4. The method of claim 3, wherein concatenated subtask layers are configured based on the task, and
wherein the shared information includes a subtask state transition matrix set indicating relationship information of subtask layer output states of each of the concatenated subtask layers.

5. The method of claim 4, wherein the extracted first data consists of feature vectors that are extracted from concatenated subtask layers.

6. The method of claim 4, wherein based on a first feature vector being extracted from a first subtask layer among the concatenated subtask layers based on the semantic encoding, association information between an output state of a second subtask layer, which is a subtask layer preceding the first subtask layer, and an output state of the first subtask layer is identified through a first subtask state transition matrix for the first subtask layer, and
wherein the first feature vector of the first subtask layer is extracted based on a second feature vector of the second subtask layer and a first dataset of the first subtask layer.

7. The method of claim 6, wherein the output state of the second subtask layer and the second feature vector are determined based on at least one or more subtask layers that are located before the second subtask layer.

8. The method of claim 6, wherein the concatenated subtask layers form a concatenated sub-deep neural network (DNN) structure, and each feature vector is extracted from each of the concatenated subtask layers through the sub-DNN.

9. The method of claim 8, wherein based on subtasks decoupled from concatenated subtask layers being present, each of the decoupled subtasks uses a different sub-DNN.

10. The method of claim 3, wherein based on the task being performed through the first data that is received based on the shared information, the task is performed through semantic decoding in the concatenated subtask layers.

11. The method of claim 10, wherein the concatenated subtask layers form a concatenated sub-deep neural network (DNN) structure, and the semantic decoding is performed in each of the concatenated subtask layers through the sub-DNN.

12. The method of claim 11, wherein based on the semantic decoding being performed in a first subtask layer among the concatenated subtask layers, the semantic decoding is performed through semantic decoding output information of a second subtask layer, which is a subtask layer preceding the first subtask layer, and a received first feature vector of the first subtask layer.

13. The method of claim 12, wherein based on subtasks decoupled from the concatenated subtask layers being present, each of the decoupled subtasks uses a different sub-DNN.

14. The method of claim 1, wherein the SCI is control information for configuring a semantic encoder and a semantic decoder and includes information on at least one of a method for selecting a neural network (NN) model, a type of a task, or a depth of a layer necessary for performing the type of the task.

15. A method comprising:
transmitting a synchronization signal to a first device;
performing a synchronization procedure with the first device based on the synchronization signal; and
transmitting control information and first data to the first device,
wherein the control information includes semantic control information (SCI),
wherein the first data is used to perform a task, and
wherein the task is performed through the first data, the SCI and shared information.

16. A first device comprising:
a transceiver; and
a processor coupled with the transceiver,
wherein the processor is configured to:
receive a synchronization signal from a second device,
performing a synchronization procedure with the second device based on the synchronization signal,
receive control information and first data from the second device, and
perform a task based on the first data,
wherein the control information includes semantic control information (SCI), and
wherein the task is performed through the first data, the SCI and shared information.

17-19. (canceled)

20. The first device of claim 16, wherein the shared information is background knowledge that the first device and the second device share based on a semantic layer, and
wherein the first data is feature information that is extracted from second data for the task based on the semantic layer.

21. The first device of claim 20, wherein the task consists of at least one or more subtasks, and
wherein the first data, which is the feature information, is extracted from the second data for the task through semantic encoding based on the shared information.

22. The first device of claim 21, wherein concatenated subtask layers are configured based on the task, and
wherein the shared information includes a subtask state transition matrix set indicating relationship information of subtask layer output states of each of the concatenated subtask layers.

23. The first device of claim 21, wherein based on the task being performed through the first data that is received based on the shared information, the task is performed through semantic decoding in the concatenated subtask layers.
